(19) United States
(12) Patent Application Publication
(10) Pub. No.: US 2017/0243202 A1
(43) Pub. Date: Aug. 24, 2017

(54) TRANSFERABLE VALUE OR RIGHTS TOKEN

(71) Applicant: Tibado Limited, Littlehampton, West Sussex (GB)

(72) Inventors: David Everett, Rustington, West Sussex (GB); Timothy Jones, Brighton, East Sussex (GB)

(21) Appl. No.: 15/516,473

(22) PCT Filed: Oct. 2, 2015
(86) PCT No.: PCT/IB2015/001756

§ 371 Date: Apr. 3, 2017

(30) Foreign Application Priority Data
Oct. 2, 2014 (GB) 1417413.0

(51) Int. Cl. G06Q 20/38; G06Q 20/36

(52) U.S. Cl. CPC G06Q 20/383; G06Q 20/3674

(57) ABSTRACT

A transferable value or rights token where the value or rights can be passed from entity to entity as required in a secure fashion. The value or rights passed in the tokens is held by the users in pockets directed by means of a controller device. The tokens are anonymous but the users need to be authenticated in order to gain access to their pockets. The tokens can be stored off-line and passed between users as required at which point the final receiver can go on-line to load or verify the token.

### FIELD OF INVENTION

This invention relates to secure electronic communications, and more particularly to a transferable value or rights token.

### BACKGROUND OF THE INVENTION

Tokens can be used to represent the value of an asset or a right to a service. We are all familiar today where payments are made by passing tokens in the form of paper (such as bills and notes) or metal (such as coins) usually referred to as a cash transaction. Earlier in history there were stones and even cowrie shells, used for this purpose.

Tickets are also a form of token which gives the holder rights to use a service, such as admission to a cinema or travelling on a bus or train. The token can also authenticate a role holder, in this sense a physical key could be the token carried by a role holder giving them the rights to open a door to some protected resource.

In recent years there have been a number of developments to manage tokens in an electronic form and today we are familiar with technologies such as smart cards which are used for making payments and for use on mass transit.

There are a number of reasons for wanting to move towards electronic tokens. Security is foremost in many such developments not just in the management of cash and all the overheads in managing its transport in a secure fashion but also the increasing problems of token (i.e. cash) counterfeits. Modern technology has been very much to the advantage of the counterfeiters in this regard, who these days are able to forge most tokens in a manner at least sufficient to fool the general populace.

Convenience and user experience are other major factors where the use of physical tokens can often be very inconvenient. Queuing for a car park ticket is a typical example.

Perhaps the biggest reason of all is the need to be able to move tokens electronically in a secure fashion. We are connected in almost all aspects of life where we not only want to be able to make payments for goods and services but also we want to purchase tickets for the cinema, airlines, trains and buses.

The financial industry has migrated to smart cards for managing payments in the physical world but has struggled in the world of the internet. In recent years the banks have issued their customers with authentication devices to help validate on-line banking. This works between card holders and their bank but is more difficult to apply between consumers and merchants. Clearly the banks wouldn't want to share secret credentials with merchants.

The rise of the mobile phone has actually exacerbated this problem by increasing the need for mobile payments while providing a security architecture that is arguably less secure than personal computers (PCs) because it is often easier to manage the security of the personal PC than a mobile device presented with a wide range of applications, many of nefarious pedigree.

The financial industry is focused on addressing the issue of mobile security using techniques such as tokenisation, which could reduce the levels of hacking cardholder data but will vary between geographical locations and will likely to take many years before global adoption.

The problems are not just restricted to the vulnerability of card holder data. There is also the increasing trend of recording consumer behaviour and worse selling it to third parties.

All of these issues indicate there is room in the market for techniques which operate more like cash, by giving the consumer a level of anonymity in their transactions as well as blocking others from tracking their spending behaviour.

On-line merchants are also suffering because of fraud in the on-line market. Not only do merchants suffer from high levels of charge back where the payment is effectively cancelled (usually after the goods or services have been provided) but they also have to pay much higher merchant fees on each transaction.

All of these issues lead to a need for an electronic payment system that operates more like cash. It should be anonymous, instant, irrevocable and not subject to charge backs. Ideally it should have minimal transaction fees.

There have been two notable schemes that have set out to address these problems, Digicash promoted by David Chaum in the 1980's and Mondex promoted by NatWest in the 1990's.

Digicash was an on-line system which was necessary to prevent double spends, which is the classical vulnerability of an electronic cash system. It used digital signatures to create a signed dollar bill or subset. The scheme was designed to blind the signature so that it was not possible to identify the consumer when the signed bill was submitted by the merchant but was not freely transferable. Broad acceptance of the Digicash scheme also suffered with the lack of ubiquity of on-line access in the 1980s.

Mondex operated off-line by the use of a secure cryptographic protocol between secure asset stores. Although very efficient in an off-line mode it suffered from the need for users to have a secure integrated circuit using public key cryptography, which were relatively expensive in the 1990s. This, along with other factors, limited the adoption of the Mondex scheme.

Accordingly, a problem to be solved is how to provide a secure electronic value transferable token system that may be used for making payments or transferring rights in an anonymous fashion.

### SUMMARY

The aforementioned problem is addressed by means of a transferable value or rights token system having the features defined in claim 1. Additional and optional features of the invention are defined in the subsidiary claims.

The transferable value or rights token system of the present invention is based on the concept of creating anonymous tokens of a value defined by the user that can be readily transferred between the participants in a way that closely relates to the handling of physical cash, but in an on-line mode. It is a particular aspect of this invention that although the handling of tokens is assumed to be through on-line communications media it is possible to define an embodiment where only the receiver of the token needs to be on-line.

Users of the Token system enroll in order to be assigned a pocket to hold the token value to which they have rights. Upon successful enrollment, each User receives credentials to enable authenticated access to their pocket. The credentials may be the traditional user name and password, or a 2-Factor authentication method using something the user owns such as a smart card and something the user knows such as a password. A preferred embodiment is based on the use of the TLS protocol where the user is issued with a client certificate to store in devices such as mobile phones and tablets or PCs. The users may arbitrarily enhance this security by requiring further access credentials to use the client certificate such as a user PIN or password.

When a user wishes to transfer a value token to another party, the user connects to the authentication module of the pocket controller device. By examining the credentials provided by the user authentication process the controller knows which pocket belongs to the entity making the authentication request.

The user may then request the creation of a value token. The controller will decrement the user's pocket and create a value token. This value token is protected by at least one cryptographic check sum although a digital signature would be an alternative security technique.

In normal operation the value token is protected by two cryptographic checksums or digital signatures created using two separate security domains. This provides a more secure approach, particularly where access to the token controller takes place over the public internet. The two security domains may be located and managed by different legal entities such that, in practice, collusion to make an attack is extremely difficult to achieve and hence highly unlikely.

The use of two cryptographic checksums to protect value tokens enables the token transfer process to consist of three steps, the creation of a token as described above and the load of a token by the receiver which has two parts. The receiver is given the token and just one of the two cryptographic checksums. This enables the controller to check the authenticity of the Token and to mark its destination to be that of the presenter's pocket but the vesting of value awaits a further step where the payee presents the second cryptographic check sum. This certificate verification technique allows the transaction process to take place in two parts but allows the payee to ensure that the authentic token has been created and cannot be spent by anybody else.

This type of operation is particularly useful when the two parties engaged in a transaction do not trust each other. In many cases the sender and receiver would trust each other. In such a case, perhaps for example when a parent is paying value to their children, it would not be necessary to split the load and verify function. The payee could be sent both cryptographic check sums in a single operation.

The token transfer system also allows an additional function for users to check the validity of the value token by providing a validate operation. In this case the receiver of the token can send it to the controller to request a validity check. The controller would check that the token is authentic and has not previously been spent. In this case the receiver would not be provided with all the information necessary to load the token, for example the sender may not have provided them with the verification cryptographic check sum. However in this case the token is still marked as unspent and could be given to another person. The load command results in the token being marked as spent even though the value may not be vested with the receiver who is still awaiting the verified cryptographic check sum.

It is an important part of the invention to recognise that it is not necessary to link the value token with information identifying either the sender or the receiver. This means that the spending behaviour of the users cannot be monitored and their activities can be truly anonymous. This may be important not only when the tokens are used for payments but also when they relate to rights perhaps for example a vote.

### BRIEF DESCRIPTION OF THE DRAWINGS

Representative embodiments of the invention will now be described by way of example only with reference to the accompanying drawings, in which:

FIG. 1 is a diagram that shows the components involved in the transfer of value tokens;

FIG. 2 is a sequence diagram that shows the complete two step load and validate for obtaining the token's value and storing it in the user's pocket;

FIG. 3 is a sequence diagram that shows a single value load operation where the validation is effectively combined with the load function visibly as two consecutive steps or transparently as a single operation;

FIG. 4 shows the sequence diagram for the validate operation where a user may want to check the validity of a token without marking it as spent;

It will be noted that throughout the appended drawings, like features are identified by like reference numerals.

### DETAILED DESCRIPTION

For a more complete explanation of the present invention and the technical advantages thereof, reference is now made to the following description and the accompanying drawings. The figures particularly relate to Tokens representing money but it will be clear that the Token could represent any currency including for example gold, silver or even a virtual currency or the rights to a resource which could for example be the electronic key to physical devices such as buildings or the logical key to resources managed for example by a computer.

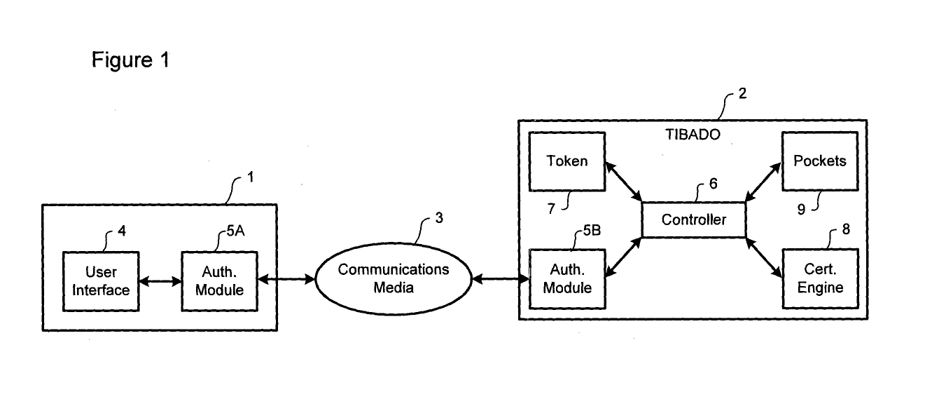

Referring to FIG. 1, the value token system of the present invention generally comprises a user's device 1 and a pocket server 2 connected for communication through a communication medium 3.

The user's device 1 may be provided as any suitable combination of hardware and software capable of supporting a user's interaction with the pocket server 2 and other users, and includes a user interface 4 and an authentication module 5A. In some embodiments, the user's device 1 may be provided as any of a mobile phone, a tablet, a PC or even a special device developed for the purpose.

The pocket server 2 may similarly be provided as any suitable combination of hardware and software capable of supporting interaction with multiple user's devices, and includes an authentication module 5B, a controller 6, a certification engine 8, a token log 7 for storing information about each token generated by the system and a non-volatile pocket memory 9 for storing a plurality of pockets. In some embodiments, the pocket server 2 may be provided as one or more computers (including a computer cluster, a network of computers or a virtual computer running in a cloud environment) connected to the communications medium 3.

The communications medium 3, may be provided as any suitable combination of communications media capable of supporting messaging between user's devices 1 and the pocket controller 2. In some embodiments, the communications medium 3 may include the public Internet.

Each person who participates in the value token transfer scheme of the present invention is assigned one or more pockets which hold the balance of their value tokens. Each pocket may store the same or a different currency depending on how the pockets were initially ascribed to the user.

Users interact with the system through the user interface 4 on their device 1 which is configured with the user's credentials in such a way that when connecting through the communications media to the pocket and token controller device 6 the authentication module 5A on the user's device can establish a secure communication session with the authentication module 5B on the token and pocket server 2.

By means of this authenticated connection to the token and pocket server 2 the user can securely create and load tokens for the transfer of value or rights.

When the user wants to create a Token, they make an authenticated request to the controller 6. The controller 6 accesses the pocket memory 9 and checks the pocket relating to the authenticated request, and as long as the balance would remain positive after the transaction it creates the value token and adds a corresponding entry in the token log 7 while debiting the balance in the relevant pocket by the value of the token.

The controller 6 also interacts with the certification engine 8 that creates the cryptographic check sums used to protect the token. The token is preferably protected by two cryptographic check sums created in different security domains. In some embodiments, each cryptographic check sum may be created by a respective different certification engine 8. In some embodiments, each certification engine 8 may be operated by respective different legal entities. This arrangement improves the security of the system by making it very difficult for a single entity (e.g. a hacker) to be able to create tokens or load value into any pockets 9. It is anticipated that in many cases the pocket server 2 will be running in servers in the cloud, and these servers may be managed by a third party. The use of the dual cryptographic check sum avoids the obvious collusion attacks.

Having created the protected token, the controller 6 passes the token back to the user by means of the secure channel between the pocket server 2 and the user's device 1.

The user may choose to store this token for an arbitrary period of time, following which they may pass the token to a potential receiver of the token (a payee) by any suitable means such as email or a messenger application for example. It should be clear that at this point the sending user (the payer) may be off-line from the pocket server 2, and may pass the token to the payee by some local communication path such as Bluetooth, for example.

Depending on the situation and the trust between the participants of the transaction, the payer may send only one of the two cryptographic check sums to the payee with the token.

With this information the payee can load the value of the token into their pocket by connecting to the pocket server 2 using an authenticated channel through the communications media 3, and then interacting with the controller 6 to execute the load operation.

Upon receipt of the token and (one) check sum, the controller 6 will use the check sum to confirm the validity of the token and will change the token's status in the token log 7 to mark it as being assigned to the payee's pocket, but will not actually vest the value of the token in the pocket. The token value is not available to the payee, and cannot be spent by the payee, until it has been vested in the pocket by the controller 6. Once the controller 6 has successfully confirmed the validity of the token, the payee now knows the token is valid and can complete the transaction with the payer by, for example, the supply of goods and/or services. When the necessary conditions have been met, the payer can will then send the second verification cryptographic check sum to the payee by any suitable communications method including for example email.

Once the payee has received the second verification cryptographic check sum, the payee can now complete the load process by connecting to the pocket server 2 by means of the authenticated channel over the communications media 3, and supplying the second token to the controller 6.

The controller 6 can then check the validity of the second verification checksum and if it is valid, the controller 6 update the balance of the payee's pocket and marks the token as spent in the token log 7.

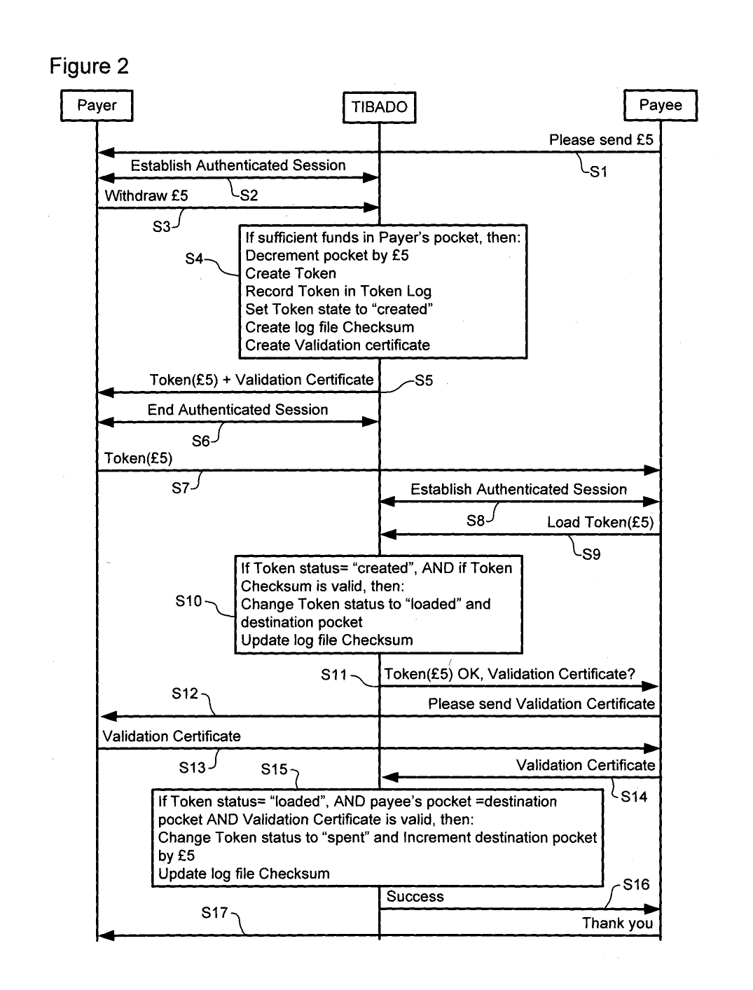

The above-described transactions can be understood in more detail by referring to FIG. 2, which illustrates operations in an example payment system. In the figures, the term “TIBADO” is used to refer to the pocket server 2 as a whole so as to avoid un-necessarily complicating the description be referring to individual components of the server 2. In this respect, it will be appreciated that most of the operations attributed to the server 2 require the cooperative operation of multiple components including, but not limited, the authentication module 5B, controller 6, certification engine(s) 8 and memories 7 and 9.

The process of FIG. 2 begins at step S1, in which the payee sends a request to the payer for the transfer of a value token for, in this example, £5.

At step S2, the payer establishes an authenticated connection to TIBADO, for example using TLS with a client certificate.

When the authenticated connection is established, the payer sends (at step S3) a request to TIBADO to withdraw a token with a value of £5.

Upon receipt of the request from the payer, TIBADO checks (at step S4) the balance of the payer's pocket and, if the requested withdrawal would leave a positive (or zero) balance in the payer's pocket, decrements the pocket balance by £5, creates a value token with the £5 value amount, and stores information about the token in the token log 7. The token information stored in the log 7 includes at least the token ID and its value as well as the state of the token which at this time is “created”. TIBADO then generates a at least one (and preferably two) cryptographic check sums. In embodiments in which only one cryptographic check sum is generated, the cryptographic check sum may form a Validation Certificate that is associated with the token. In embodiments in which two cryptographic check sum are generated, one of the cryptographic check sums may be embedded within (or attached to) the token, while the other cryptographic check sum forms a Validation Certificate associated with the token. In some embodiments, the token information stored in the log 7 may also include one (or both) of the cryptographic check sums, but this is not essential.

In some embodiments, the process of generating the Token at step S4 is executed as an atomic database operation, in that it cannot be divided or interrupted during execution. This implies that the process is isolated from other processor function, which offers protection against some potential hacker attacks.

At step S5, TIBADO returns the token to the payer across the authenticated channel.

If desired, once the payer has received the token from TIBADO, the payer may (at step S6) end the Authenticated session with TIBADO.

At step S7, the payer sends the token to the payee. In embodiments in which the token is protected by two cryptographic check sums, then only one of the cryptographic check sums may be sent to the payee at this time. In other embodiments in which the token is protected by only one cryptographic check sum, then the token may be sent to the payee without the cryptographic check sum.

At step S8, the payee establishes an authenticated connection to TIBADO, for example using TLS with a client certificate, and at step S9 requests the controller to load the token to the payee's pocket.

Upon receipt of the payee's request (which includes the token and any check sum supplied by the payer) TIBADO (at step S10) checks the token log 7 to determine whether or not the status of the received token is still “created” (that is, it has not already been “loaded” or “spent” to another destination pocket) and the supplied cryptographic check sum to determine whether or not the received token is valid. As may be appreciated, the first of these checks prevents the problems of “double spending” or duplication of tokens. If either of these checks fails, TIBADO may reject the load request, and send a corresponding failure message to the payee. Otherwise, TIBADO changes the state of the token in the token memory 7 to show the status as “loaded”, and also updates the token information in the log 7 to indicate the payee's pocket as the intended destination. The controller 6 may also ensure the integrity of the pocket memory 9 and token log 7 by the use of additional cryptographic checksums as necessary and appropriate.

In some embodiments, the process of loading the Token at step S10 is executed as an atomic database operation, in that it cannot be divided or interrupted during execution.

At step S11, TIBADO sends a reply to the payee confirming that the token is valid and loaded to the payee's pocket but the value is not yet vested. The confirmation message may also request the payee to provide the Validation Certificate. If desired, the payee may end the authenticated session with TIBADO following receipt of confirmation that he token is valid.

At step S12, the payee communicates with the payer to request the validation certificate for the token that will validate or certify the transaction so that the value can be vested in the payee's pocket.

At step S13, and based on some agreed terms between the payer and the payee (for example the payer receives goods from the payee), the payer sends the validation certificate to the payee. As noted above, the validation certificate may take the form of a cryptographic check sum generated by TIBADO for the token.

The payee may then establish a new authenticated connection with TIBADO and sends (at step S14) the validation certificate to TIBADO. Upon receipt of the validation certificate, TIBADO uses the validation certificate (at step S15) to check the previously received token, and, if the validation check is successful, TIBADO vests the token in the payee's pocket by marking the appropriate entry in the token log 7 as showing the token's new state of “spent” and updating the balance of the payee's pocket by the value of the token. If the validation check fails, TIBADO may reject the load request, and send a corresponding failure message to the payee.

In some embodiments, the process of vesting the Token at step S15 is executed as an atomic database operation, in that it cannot be divided or interrupted during execution.

At step S16, TIBADO sends a confirmation message to the payee confirming the results of the processing at step S15. In the event that the processes was successful, the confirmation message indicates that the token value (in this case, £5) has been added to the payee's pocket. At step S17, the payee may send a confirmation “thank you” message to the payer indicating that the transaction has been successfully completed.

As may be appreciated from the foregoing description, the system of the present invention enables value to be exchanged between users (payer and payee) by means of a token that is generated by the pocket server 2, and passed between the server 2 and each of the involved users. In principle, the server 2 can identify each of the two users, based on the information exchanged during the set-up of authenticated sessions with each party. However, there is no requirement that the token (or the token log 7) contain any information that identifies either user, nor is there any need for the server 2 to participate in the transfer of the token (and its associated validation certificate) between the parties. As such, the system of the present invention supports secure transfer of value between the users, while at the same time ensuring anonymity of the two users

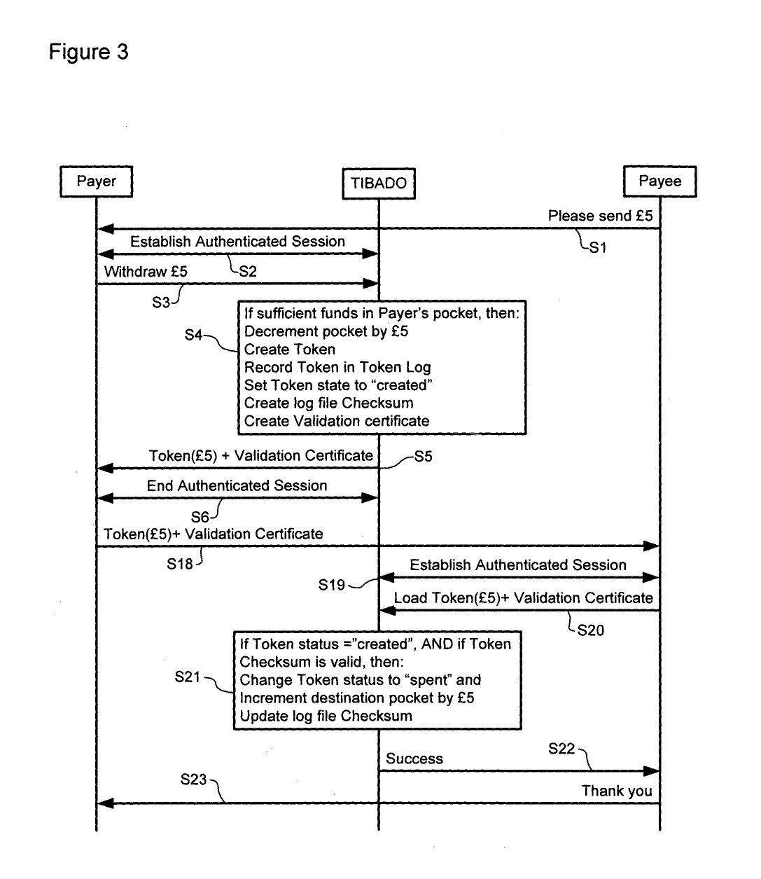

FIG. 3 shows an embodiment in which the payer supplies the Validation Certificate to the payee at the same time as the token. In this case, the Validation Certificate may be attached to the token itself, so that the token and the validation certificate may be treated as a single entity. This embodiment may be appropriate in cases where there is a trust relationship between the payer and the payee. Behind the scenes TIBADO may choose to use one or two cryptographic check sums as appropriate to the particular implementation and business and security requirements.

In the embodiment of FIG. 3, the steps S1-S6 are substantially identical to the corresponding steps described above with reference to FIG. 2, and so will not be further described in detail. At step S18, the payer sends the token and the validation certificate to the payee.

At step S19, the payee establishes an authenticated connection to TIBADO, for example using TLS with a client certificate, and at step S20 requests the controller to load the token (this time accompanied by the Validation Certificate) to the payee's pocket.

Upon receipt of the payee's request (which includes the token and the Validation Certificate) TIBADO (at step S21) checks the token log 7 to determine whether or not the status of the received token is still “created” (that is, it has not already been “loaded” or “spent” to another destination pocket) and the Validation Certificate to determine whether or not the received token is valid. If either of these checks fails, TIBADO may reject the load request, and send a corresponding failure message to the payee. Otherwise, TIBADO changes the state of the token in the token memory 7 to show the status as “spent”, and updates the balance of the payee's pocket by the value of the token.

In some embodiments, the process of vesting the Token at step S21 is executed as an atomic database operation, in that it cannot be divided or interrupted during execution.

At step S22, TIBADO sends a confirmation message to the payee confirming the results of the processing at step S21. In the event that the processes was successful, the confirmation message indicates that the token value (in this case, £5) has been added to the payee's pocket. At step S23, the payee may send a confirmation “thank you” message to the payer indicating that the transaction has been successfully completed.

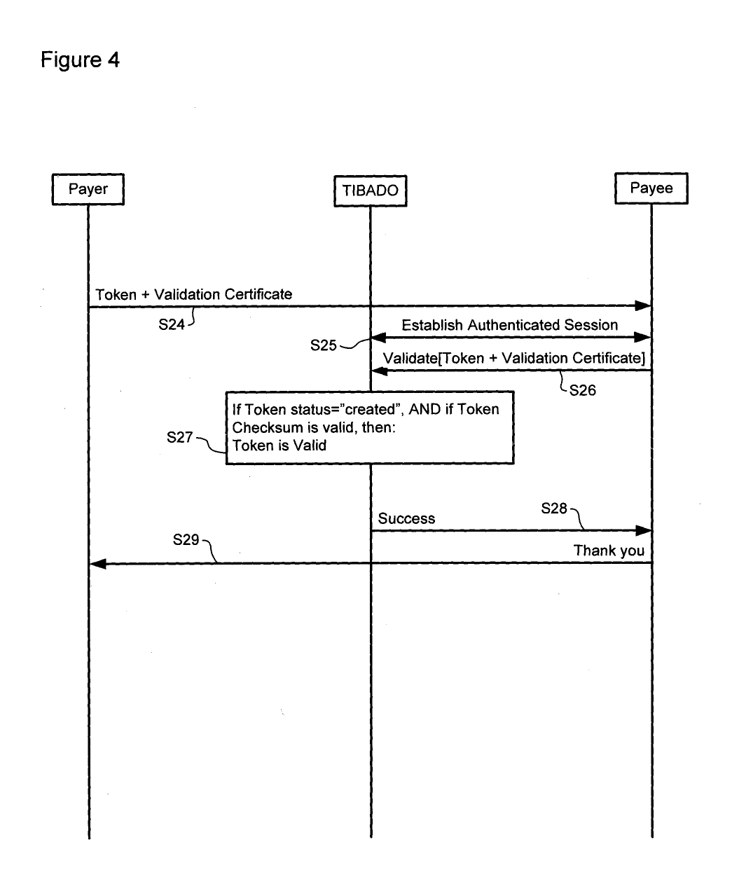

In FIG. 4 an alternative method is provided that allows the potential payee to check that a token is valid without marking it in the token memory as loaded. In other words the state of the token in the token memory is unchanged.

At step S24, the payer sends the token and the validation certificate to the payee.

At step S25, the payee establishes an authenticated connection to TIBADO, for example using TLS with a client certificate, and at step S26 requests the controller 6 to validate the token. The information in the token may be incomplete, for example it may only contain only one cryptographic check sum. TIBADO is able to check (at step S27) the cryptographic check sum and also the state of the token as “created”, “loaded”, or “spent”. If it is in the “created” state it means it is fresh and can be loaded by anybody. Participants are of course aware that the state of a token could be changed straight after the validation request by anybody else that has access to the token.

At step S28, TIBADO sends a confirmation message to the payee confirming the results of the processing at step S27. In the event that the validation was successful, the confirmation message indicates that the token is valid. At step S28, the payee may send a confirmation “thank you” message to the payer indicating that the token has been received and is valid.

In the embodiments described above with reference to FIGS. 2-4, a token and verification certificate are generated by a pocket server 2 and passed to a first user (referred to as a payer). The payer subsequently passes the token and verification certificate to a second user (referred to as a payee), in either a single transaction, or in two separate transactions. Thereafter, the payee passes the token and the verification certificate back to the pocket server 2 with a request to either validate the token, or load the value of the token into the payee's pocket. However, it will be appreciated that this scenario may be varied without departing from the intended scope of the claims. For example, it is not strictly necessary for the token itself to be passed between the pocket server 2 and each of the involved users. In particular, it is possible to achieve the desired value transfer by passing just the token identifier and at least one of the associated cryptographic checksums. It may be convenient to also pass the token value, but this is not strictly necessary either, because a payee may determine the token value by querying the pocket server 2 in a manner directly analogous to the verification query described above with reference to FIG. 4.

In other embodiments, the token may comprise a token identifier, one cryptographic check sum, and (optionally) the token value. In these embodiments, the verification certificate (if any) may comprise the second cryptographic check sum. With this arrangement, the token includes sufficient information for value transfer and validation of the token, and the verification certificate enables the two-part value loading operation described above with reference to FIG. 2.

1. An electronic token value transfer system comprising:
a pocket memory configured to store a plurality of pockets, each pocket being associated with a respective user of the system and storing a value balance owned by the respective user;
a token log configured to store information of each token created by the system, the information including at least a token identifier, a value, and a status of the token;
a controller configured to respond to an authenticated withdrawal request message including a first value amount, to perform the steps of:
identify a first pocket associated with the withdrawal request message;
deduct the first amount from the first pocket;
generate a token containing the first amount;
record information of the generated token in the token log, the information of the generated token including a first status of the token; and
return the token as a response to the authenticated withdrawal request message; and
the controller being configured to respond to an authenticated load request message including at least an identifier of the token, to perform the steps of:
identify a second pocket associated with the load request message;
add the first amount to the second pocket; and
update the information of the token in the token log to identify a second status of the token.

2. The system as claimed in claim 1, wherein the first pocket is identified based on authentication information associated with the withdrawal request message.

3. The system as claimed in claim 1, wherein generating the token comprises generating a cryptographic check sum.

4. The system as claimed in claim 3, wherein the cryptographic check sum is a digital signature.

5. The system as claimed in claim 3, wherein the cryptographic check sum is included in the token.

6. The system as claimed in claim 3, wherein a second cryptographic check sum is generated, the second cryptographic check sum being stored in a validation certificate.

7. The system as claimed in claim 6, wherein the validation certificate is returned as part of the response to the authenticated withdrawal request message.

8. The system as claimed in claim 6, wherein the cryptographic check sums are generated in respective different security domains.

9. The system as claimed in claim 1, wherein the controller is configured to add the first amount to the second pocket only if the token is valid.

10. The system as claimed in claim 9, wherein the token is associated with two cryptographic check sums, and wherein controller is configured to add the first value to the second pocket by:
receiving a first one of the cryptographic check sums; and
using the first cryptographic check sum to determine a validity of the token, and responsive to determining that the token is valid, updating the information of the token in the token log to identify a third status of the token, and the second pocket as a destination;
subsequently receiving the second one of the cryptographic check sums; and
using the second cryptographic check sum to determine a validity of the token, and responsive to determining that the token is valid, adding the first amount to the second pocket.

11. The system as claimed in claim 10, wherein the first and second cryptographic check sums are received in respective different communication sessions.

12. The system as claimed in claim 11, wherein the controller is further configured to add the first amount to the second pocket only if the information of the token in the token log identifies the third status of the token and the second pocket as a destination.

13. The system as claimed in claim 1, wherein the controller is configured to add the first amount to the second pocket only if the information of the token stored in the token log does not include the second status.

14. An electronic token value transfer method comprising:
maintaining a pocket memory configured to store a plurality of pockets, each pocket being associated with a respective user of the system and storing a value balance owned by the respective user;
maintaining a token log configured to store information of each token created by the system, the information including at least a token identifier, a value, and a status of the token; and
responding to an authenticated withdrawal request message including a first value amount by performing the steps of:
identifying a first pocket associated with the withdrawal request message;
deducting the first amount from the first pocket;
generating a token containing the first amount;
recording information of the generated token in the token log, the information of the generated token including a first status of the token; and
returning the token as a response to the authenticated withdrawal request message; and
responding to an authenticated load request message including at least an identifier of the token by performing the steps of:
identifying a second pocket associated with the load request message;
adding the first amount to the second pocket; and
updating the information of the token in the token log to identify a second status of the token.

15. The method as claimed in claim 14, wherein the first pocket is identified based on authentication information associated with the withdrawal request message.

16. The method as claimed in claim 14, wherein generating the token comprises generating a cryptographic check sum.

17. The method as claimed in claim 16, wherein the cryptographic check sum is a digital signature.

18. The method as claimed in claim 16, wherein the cryptographic check sum is included in the token.

19. The method as claimed in claim 16, wherein a second cryptographic check sum is generated, the second cryptographic check sum being stored in a validation certificate.

20. The method as claimed in claim 19, wherein the validation certificate is returned as part of the response to the authenticated withdrawal request message.

21. The method as claimed in claim 19, wherein the cryptographic check sums are generated in respective different security domains.

22. The method as claimed in claim 14, wherein the first amount is added to the second pocket only if the token is valid.

23. The method as claimed in claim 22, wherein the token is associated with two cryptographic check sums, and wherein adding the first value to the second pocket comprises:
receiving a first one of the cryptographic check sums;
using the first cryptographic check sum to determine a validity of the token, and responsive to determining that the token is valid, updating the information of the token in the token log to identify a third status of the token, and the second pocket as a destination;
subsequently receiving the second one of the cryptographic check sums; and
using the second cryptographic check sum to determine a validity of the token, and responsive to determining that the token is valid, adding the first amount to the second pocket.

24. The method as claimed in claim 23, wherein the first and second cryptographic check sums are received in respective different communication sessions.

25. The method as claimed in claim 14, wherein the first amount is added to the second pocket only if the information of the token in the token log identifies the third status of the token and the second pocket as a destination.

26. The method as claimed in claim 14, wherein the first amount is added to the second pocket only if the information of the token stored in the token log does not include the second status.

27. A non-transitory computer readable medium storing software instructions that, when executed on a processor, control the processor to implement an electronic token value transfer method comprising:
maintaining a pocket memory configured to store a plurality of pockets, each pocket being associated with a respective user of the system and storing a value balance owned by the respective user;
maintaining a token log configured to store information of each token created by the system, the information including at least a token identifier, a value, and a status of the token; and
responding to an authenticated withdrawal request message including a first value amount by performing the steps of:
identifying a first pocket associated with the withdrawal request message;
deducting the first amount from the first pocket;
generating a token containing the first amount;
recording information of the generated token in the token log, the information of the generated token including a first status of the token; and
returning the token as a response to the authenticated withdrawal request message; and
responding to an authenticated load request message including at least an identifier of the token by performing the steps of:
identifying a second pocket associated with the load request message;
adding the first amount to the second pocket; and
updating the information of the token in the token log to identify a second status of the token.
